(19) United States
(12) Patent Application Publication
(10) Pub. No.: US 2007/0237088 A1
(43) Pub. Date: Oct. 11, 2007

(54) Apparatus and method for providing network security

(75) Inventor: Frederick Hidle, Landsdale, PA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL. INC

(21) Appl. No.: 11/398,176

(22) Filed: Apr. 5, 2006

(51) Int. Cl. H04J 1/16; H04L 12/56

(52) U.S. Cl. 370/252; 370/389

(57) ABSTRACT

Devices, systems and methods for network traffic monitoring for a network are disclosed. The exemplary device may include a connection to a physical media and a connection to a media access controller of the Ethernet network. The exemplary device may have a sensor for identifying a disconnect in the local Ethernet network; a memory for storing media access controller addresses on the Ethernet network; and an access controller that broadcasts packets to media access controller addresses stored in memory and erases the access controller addresses in memory when the sensor identifies a disconnect. The access controller may also prevent broadcasts of packets by the media access controller to the media access controller addresses not stored in the memory. The device may also have a filter for identifying packets of one or more ports of the Ethernet network. The memory may store ports of the Ethernet network. The access controller may prevent broadcasts of packets to multiple identified known media access controller addresses from a single identified port.

### FIELD OF THE INVENTION

The present invention relates generally to computer networks, and more particularly to providing security for networks.

### BACKGROUND OF THE INVENTION

Networks provide communications from one node located on a network to other nodes located on the network. The nodes are typically personal computers, workstations, file or print servers, or any other suitable device and utilize the network to communicate information to other nodes on the network. For example, a workstation on a network may communicate with a server or a printer over the network.

Those skilled in the art will appreciate that there are many different types of networks. For example, the network may be a Local Area Network (LAN). The nodes on the LAN may communicate with other LANs via, for example, a Wide Area Network (WAN). To provide routing of the data within a network and to various other connected networks, the network may use equipment to facilitate routing of data. For example, switches, routers, hubs, or bridges may be used to transmit and communicate data between nodes and networks.

The network may use one or more protocols to allow the nodes to receive and transmit data. One of the most commonly used protocols is Ethernet. Ethernet allows nodes to package and transmit data to a desired node, and, once received, unpackage the data at the desired node. Ethernet switches are part of a network and act as conduits to transfer packets of data within network nodes. Ethernet switches logically partition these packets to travel directly between their sources and their destinations.

Each node on a network has a unique network address called a data link control (DLC) address or media access control (MAC) address. Sending the packets directly to the desired media access control address increases security as users at varying nodes are less apt to access other user's data. By sending the packets directly to the desired location and reducing the number of packets on other segments, the overall performance and efficiency is improved. Accordingly, an efficient and effective device system and method is needed for ensuring network security and to prevent spying on the network by transmitting packets to an illegitimate node.

### SUMMARY OF THE INVENTION

It is, therefore, an objective of the present invention to provide devices, systems, and methods to monitor network traffic in a process control network.

In one embodiment, a network traffic monitoring device for an Ethernet network may be connected to a connection to a physical media and a media access controller of the Ethernet network. The monitoring device may have a filter for identifying packets of one or more ports of the Ethernet network and a filter for identifying packets of one or more known media access controller addresses on the Ethernet network. The monitoring device may have a memory for storing known media access controller addresses and ports on the Ethernet network. An access controller or the monitoring device may prevent broadcasts of packets to multiple identified known media access controller addresses from a single identified port.

In another embodiment, a network traffic monitoring device for an Ethernet network may be connected to a connection to a physical media and a media access controller of the Ethernet network. The monitoring device may have a filter for identifying packets of one or more known media access controllers and a memory for storing known media access controller addresses. An access controller of the monitoring device may prevent broadcasts of packets by the media access controller to the media access controller addresses not stored in the memory.

In another embodiment, a network traffic monitoring device for an Ethernet network may be connected to a connection to a physical media and a media access controller of the Ethernet network. The monitoring device may have a sensor for identifying a disconnect in the local Ethernet network and a memory for storing media access controller addresses on the Ethernet network. An access controller of the monitoring device may broadcast packets to media access controller addresses stored in memory and erases the access controller addresses in memory when the sensor identifies a disconnect.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1 is a generalized schematic of an exemplary Ethernet communications network according to an exemplary embodiment of the present invention.

FIG. 2 is a block diagram of the Ethernet network monitoring device according to a first exemplary embodiment of the present invention.

FIG. 3 is a block diagram of the Ethernet network monitoring device according to a second exemplary embodiment of the present invention.

FIG. 4 is a block diagram of the Ethernet network monitoring device according to a third exemplary embodiment of the present invention.

FIG. 5 is a flow chart illustrating a first exemplary embodiment of the present invention.

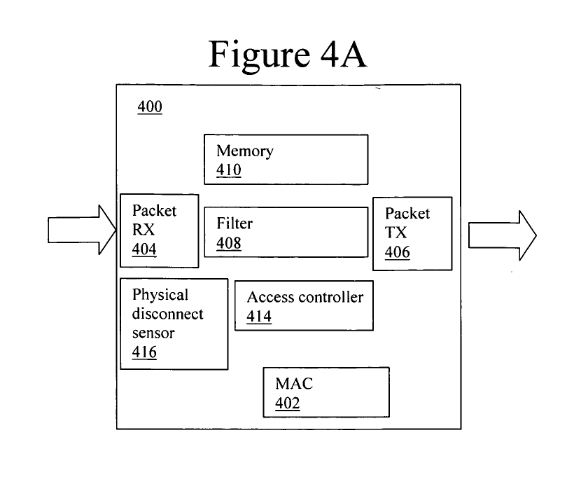

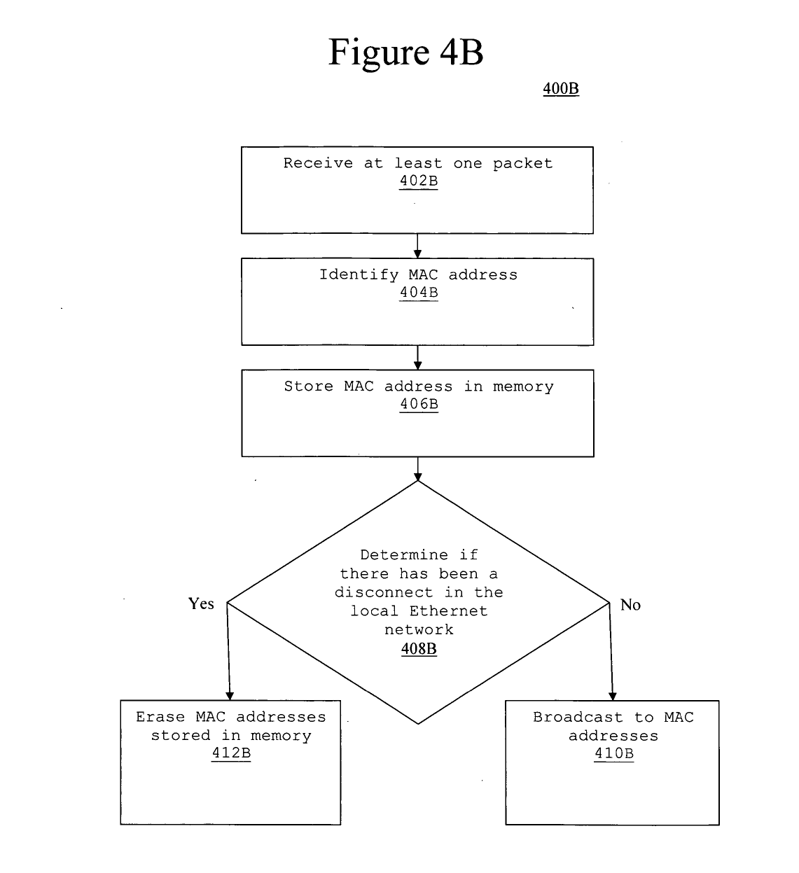

FIG. 4 is a flow chart illustrating a second exemplary embodiment of the present invention.

### DETAILED DESCRIPTION OF THE INVENTION

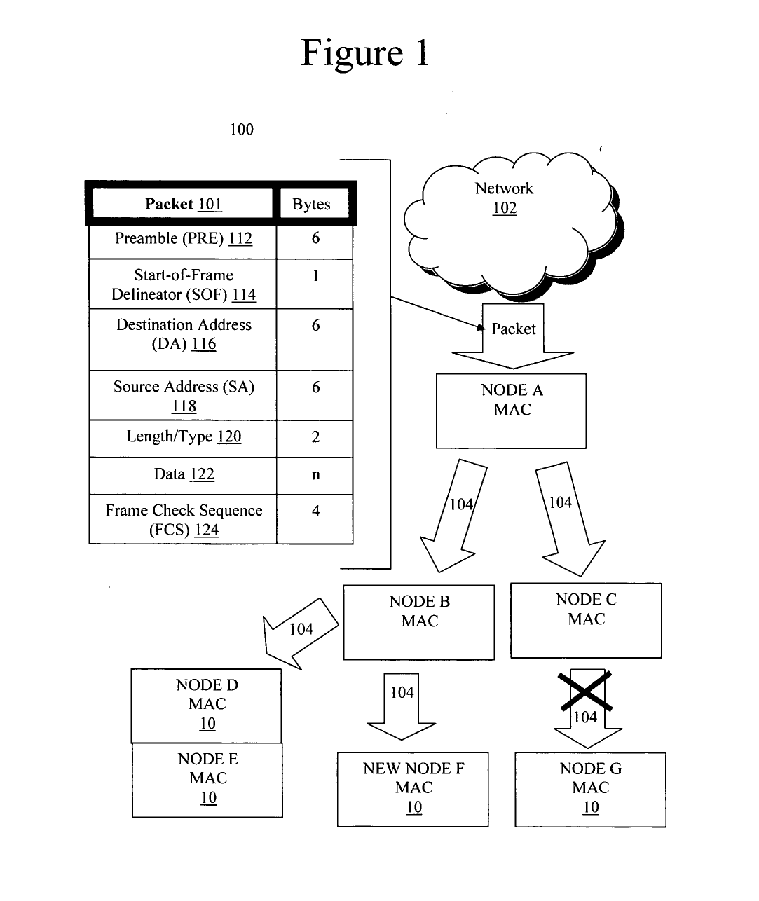

An exemplary Ethernet network 100, as shown in FIG. 1, transmits packets 101 throughout the various nodes of the network 100 in order to transmit the packet 101 to the packet's 101 final destination. Packets 101 of data are transferred from originating node or network 102 to Node A. The nodes of the network can take the form of, for example, a switch, a router, a personal computer, workstation, file server, or any other suitable device. Node A receives the packet and transmits a copy of the packet to surrounding local media access controller (MAC). A hacker may utilize this process to gain information regarding the device of the network.

Embodiments of the invention may be implemented to prevent unwanted availability of this information to unknown individuals. Packets 101 of data may be stored in a standardized Ethernet frame format including the following seven fields: preamble (PRE) 112, start-of-frame delineator (SOF) 114, destination address (DA) 116, source addresses (SA) 118, length/type 120, data payload 122, and frame check sequence (FCS) 124, as shown in FIG. 1.

Preamble (PRE) 112 consists of six bytes of data and is an alternating pattern of ones and zeros that tells the receiving node that a frame is coming, and provides a means to synchronize the frame-reception portions of receiving physical layers with the incoming bit stream. Start-of-frame delineator (SOF) 114 may include one byte of data and is an alternating pattern of ones and zeros, ending with two consecutive 1-bits indicating that the next bit is the left-most bit in the left-most byte of the destination address. Destination address (DA) 116 may include six bytes of data and identifies which station(s) should receive the frame. The left-most bit in the destination address (DA) field may indicate whether the address is an individual address (indicated by a 0) or a group address (indicated by a 1). The second bit from the left may indicate whether destination address (DA) 116 is globally administered (indicated by a 0) or locally administered (indicated by a 1). Source address (SA) 118 may include six bytes and identifies the sending station. Source address (SA) 118 is generally an individual address and the left-most bit in the SA field is generally “0”. Length/type 120 may include two bytes of data and indicates the length/type packet data. Data payload 122 is a sequence of “n” bytes of any value, where “n” is less than or equal to a set amount of bytes. If the length of data payload 122 field is less than 46 bytes, data payload 122 field may be extended by adding a filler (a pad) sufficient to bring the data field length to 46 bytes. Frame check sequence (FCS) 124 may include four bytes of data and contains a 32-bit cyclic redundancy check (CRC) value, which is created by sending media access controller (MAC) 108 and is recalculated by receiving media access controller (MAC) 108 to check for damaged frames. Frame check sequence (FCS) 124 is generated over the destination address (DA) 116, source address (SA) 118, length/type 120, and data payload 122 fields.

The physical media connection (PHY) 104 allows the frame packet 101 to travel from the physical hardware to the network media access controller (MAC). The physical media connection (PHY) 104 may also be defined based on the hardware type and network interface. According to an exemplary embodiment, the physical media connection (PHY) 104 provides packets 101 and control signals to monitoring device 200, 300, 400 described in greater detail later herein. The monitoring device 200, 300, 400 may be used to prevent the media access controller (MAC) of a node from performing the standard operations.

According to a first exemplary embodiment, when the packet 101 is received by the MAC of Node B, a monitoring device 200 may prevent the packet 101 from being transferred to Node D due to the device having multiple MAC addresses, Node D and Node C, on a given port. The first exemplary embodiment may prevent making information available to a spying device that may be coupled to a legitimate node of the network. For example, Node D may be a legitimate node while node E may be a spying node for gathering information from packets transmitted over the network. The monitoring device 200 according to the first exemplary embodiment may prevent the spying node from joining the network.

According to a second exemplary embodiment, when the packet 101 is received by the MAC of Node B, a monitoring device 300 may prevent the packet 101 from being transferred to new Node F due to the node being new and unknown to Node B. A standard network protocol may maintain a list of surrounding nodes. When a new node is detected, the node receiving the packet 101 may add the MAC address of the new node to list of surrounding nodes to distribute packets 101. The monitoring device 300 may prevent the addition of new nodes to the list of surrounding nodes. This prevents spying on the network by adding a new device with a node designed to gather information on the network.

According to a third exemplary embodiment, when the packet 101 is received by the MAC of Node C, a monitoring device 400 may prevent the packet 101 from being transferred to a disconnected Node G. A standard node may continue to broadcast to a node that has been disconnected from the network. This may allow an individual to receive packets 101 destined for the disconnect node G. The monitoring device 400 may prevent the transmission of packets 101 to disconnected nodes. The monitoring device 400 detects when a physical disconnect has occurred and erases the stored list of surrounding nodes when a disconnect is detected.

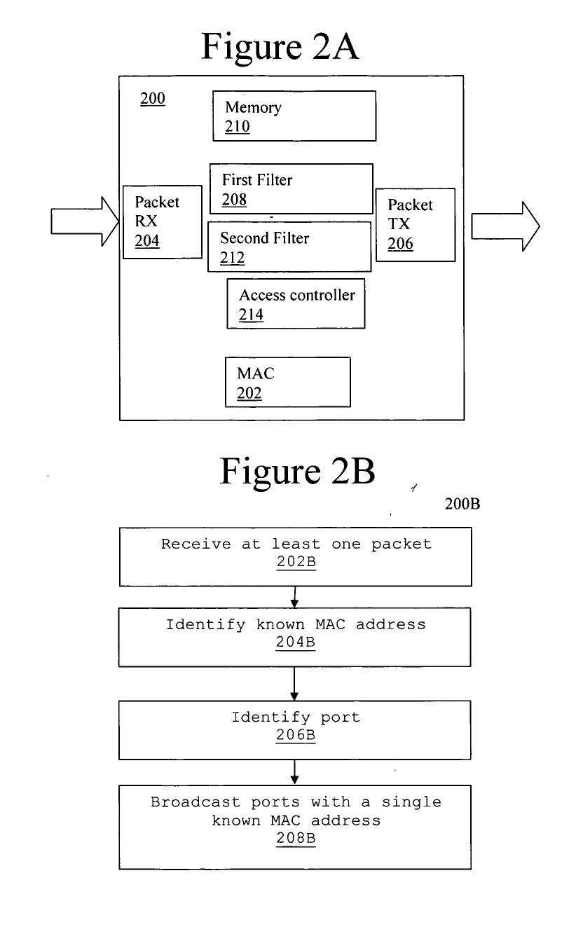

Referring to FIG. 2A, the monitoring device 200 according to the first exemplary embodiment may be implemented within a device of a node. The monitoring device 200 prevents the transmission of packets to multiple MACs for a given port. The MAC 202 of the node receives packets 101 in a receiving buffer 204. The MAC 202 of the node duplicates the packet 101 and transmits the packet 101 via a transmission buffer 206 to MACs of other nodes. The monitoring device 200 may have a first filter 208. The first filter 208 determines the MAC address of nodes that transmitted the packet 101 to the node. This address is stored in memory 210 of the MAC as a surround node on the network. The monitoring device 200 also has a second filter 212. The second filter may be used to determine the port of the packet 101. The first filter 208 and second filter 212 are illustrated as being separate components, however, one skilled in the art will appreciate that the filters 208, 212 may be combined into the same process device.

An access controller 214 determines if a port is associated with multiple MAC addresses. If the port is associated with multiple MAC addresses, the MAC address associated with the port are removed from memory 210. The MAC 202 is prevented from transmitting to multiple MAC address associated with a single port. Thus a MAC that may be attached to a port for spying purposes is prevented from receiving packets 101.

Referring to FIG. 2B, a first exemplary method 200B according to the first exemplary embodiment may be implemented within a device of a node. The node receives a packet (Block 202B). The node identifies the MAC address of the packet 101 (Block 204B). The node identifies the port associated with the MAC address (Block 206B). If the MAC address is determined to be associated with a port that is currently associated with another MAC address stored in memory, the MAC address stored in memory is removed and the MAC address of the packet 101 is prevented from being added to the memory of the node. The node is allowed to broadcast to ports associated with a single port (Block 208B).

The first exemplary method 200B is not limited to automatically removing the MAC addresses from memory 210 or preventing the addition of MAC addresses. The first exemplary method 200B may incorporate additional processes to allow the network to work efficiently without compromising security. The monitoring device 200 may request permission from an administrator or record the occurrence for subsequent review. For example, the monitoring device 200 may transmit a message to an administrator and hold off on broadcasting packets associated with the second MAC address until the administrator authorizes the addition of multiple MAC addresses for a given port. In another exemplary embodiment the monitoring device 200 may perform additional tests on the network or packet in order to determine if the multiple MAC addresses are legitimate.

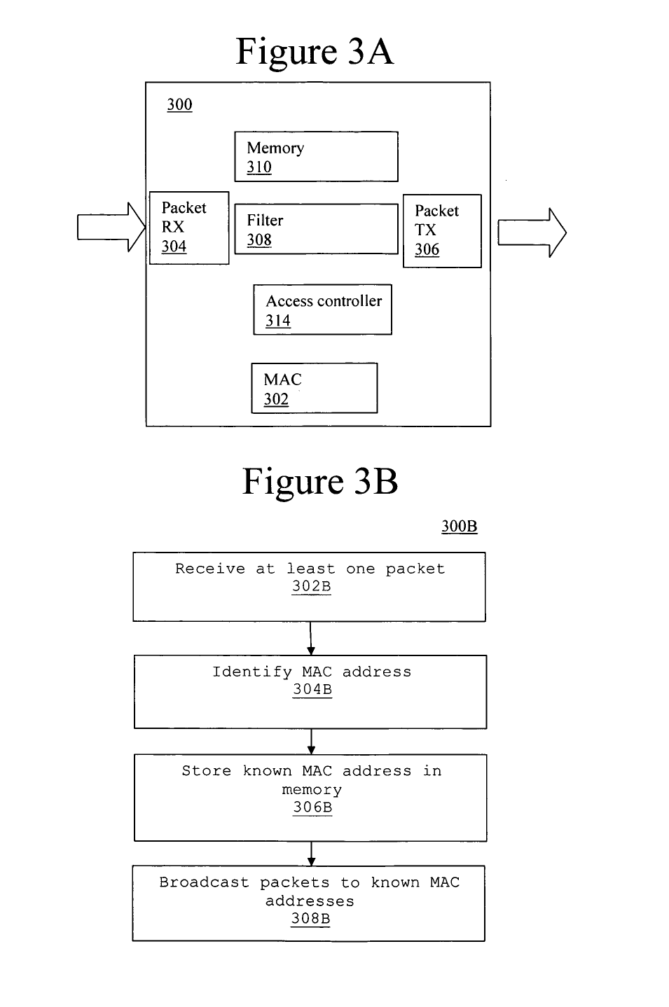

Referring to FIG. 3A, the monitoring device 300 according to the second exemplary embodiment may be implemented within a device of a node. The monitoring device 300 prevents the transmission of packets to new MAC addresses. The MAC 302 of the node receives packets 101 in a receiving buffer 304. The MAC 302 of the node duplicates the packet 101 and transmits packet 101 via a transmission buffer 306 to MACs of other nodes. The monitoring device 300 may have a first filter 308. The first filter 308 determines the MAC address of nodes that transmitted the packet 101 to the node. If the MAC is a known node on the network, the address may be stored in memory 310.

An access controller 314 determines if the address is associated with known MAC address in memory 310. If the MAC address is not associated with a known MAC address, the MAC address associated with the node may be removed from memory 310. The MAC 302 is prevented from transmitting to MAC addresses associated with unknown devices. Thus a MAC that may be attached for spying purposes is prevented from receiving packets 101.

Referring to FIG. 3B, a second exemplary method 300B according to the second exemplary embodiment may be implemented within a device of a node. The node receives a packet 101 (Block 302B). The node identifies the MAC address of the packet 101 (Block 304B). If the MAC address is determined to be an unknown MAC address, the MAC address may be removed from memory 310. This prevents broadcasting to unknown devices. If the MAC address is determined to be a known MAC address, the MAC address is stored or remains in memory 310. The node is allowed to broadcast to ports associated with a single port (Block 308B).

The list of known MAC addresses may be previously stored in memory 310. Known MAC addresses may be downloaded to the node when the node is connected to the network. The second exemplary method 300B is not limited to automatically removing the MAC addresses from memory or preventing the addition of MAC addresses. The second exemplary method 300B may incorporate additional processes to allow the network to work efficiently without compromising security. The monitoring device 300 may request permission from an administrator or record the occurrence for subsequent review. For example, the monitoring device 300 may transmit a message to an administrator and hold off on broadcasting packets 101 associated with the unknown MAC address until the administrator authorizes the addition of the unknown MAC address. In another example, the monitoring device 300 may perform additional tests on the node, network, and/or packet in order to determine if the unknown MAC address is legitimate.

Referring to FIG. 4A, the monitoring device 400 according to the second exemplary embodiment may be implemented within a device of a node. The monitoring device 400 prevents the transmission of packets 101 when there has been a disconnect in the network. The MAC 402 of the node receives packets 101 in a receiving buffer 404. The MAC 402 of the node duplicates the packet 101 and transmits the packet 101 via a transmission buffer 406 to MACs of other nodes. The monitoring device 400 may have a first filter 408. The first filter 408 determines the MAC address of nodes that transmitted the packet 101 to the node. This address is stored in memory 410 if the MAC is a surrounding node on the network. The MAC 402 broadcasts packets to MAC addresses stored in memory 410.

A physical disconnect sensor 416 determines if there has been a disconnect in the network. If a disconnect is detected, an access controller 414 may erase the MAC addresses stored in memory 410. The MAC 402 is thus prevented from transmitting to nodes if a disconnect has been detected. Thus a network connection that has been severed for purposes of spying may be prevented from receiving packets 101.

Referring to FIG. 4B, a third exemplary method 400B according to the third exemplary embodiment may be implemented within a device of a node. The node receives a packet 101 (Block 402B). The node identifies the MAC address of the packet 101 (Block 404B). The MAC 402 stores the MAC address associated with the packet 101 in memory 410 (Block 206B). The physical disconnect sensor 416 determines if there has been a disconnect in the network (Block 408B). If no disconnect has been detected (“No” branch), the MAC 402 is allowed to broadcast packets 101 to the MAC addresses stored in memory 410 (Block 410B). If a disconnect has been detected (“Yes” branch), the access controller 414 erases the MAC addresses stored in memory 410 (Block 412B).

The third exemplary method 400B is not limited to automatically removing the MAC addresses from memory 410 or preventing the addition of MAC addresses. The third exemplary method 400B may incorporate additional processes to allow the network to work efficiently without compromising security. The monitoring device 400 may request permission from an administrator or record the occurrence for subsequent review. For example, the monitoring device 400 may transmit a message to an administrator and hold off on broadcasting packets associated with the disconnect until the administrator authorizes rebroadcasting to MAC addresses stored in memory 410. In another exemplary embodiment the monitoring device 200 may perform additional tests on the network or packet 101 in order to determine if the disconnect is an attempt to spy on the network.

The exemplary embodiments may be implemented as separate, independent devices, methods, and/or systems or the embodiments may be implemented in combination as a single device, method, or system. The monitoring device 200, 300, 400 may be implemented using a hardwired circuitry or a Field Programmable Gate Array (FPGA) program to perform the desired operations. Architecturally in terms of hardware, the monitoring device 200, 300, 400 may also include a processor, memory, and one or more input and output interface devices. A local interface may have additional elements, which are omitted for simplicity, such as controllers, buffers (caches), drivers, repeaters, and receivers, to enable communications. Further, the local interface may include address, control, and/or data connections to enable appropriate communications among the components of a network.

The systems and methods may also be incorporated in software used with a computer or other suitable operating device of the monitoring device 200, 300, 400. The software stored or loaded in the memory may include one or more separate programs, each of which comprises an ordered listing of executable instructions for implementing the methods and systems of the invention. The software may work in conjunction with an operating system. The operating system essentially controls the execution of the computer programs, such as the software stored within the memory, and provides scheduling, input-output control, file and data management, memory management, and communication control and related services. The system and method may also include a Graphic User Interface (GUI) to allow the administrator or user to enter constraints associated with the monitoring device 200, 300, 400 managing network traffic.

Persons skilled in the art will appreciate that the present invention can be practiced by other than the described examples and embodiments, which are presented for purposes of illustration rather than of limitation and that the present invention is limited only by the claims that follow.

What is claimed is:

1. A network traffic monitoring device for an Ethernet network, comprising:
a connection to a physical media;
a connection to a media access controller of the Ethernet network;
a filter for identifying packets of one or more ports of the Ethernet network;
a filter for identifying packets of one or more known media access controller addresses on the Ethernet network;
a memory for storing known media access controller addresses and ports on the Ethernet network; and
an access controller that prevents broadcasts of packets to multiple identified known media access controller addresses from a single identified port.

2. The network monitoring device of claim 1, wherein the access controller prevents broadcasts of packets by the media access controller to the media access controller addresses not stored in the memory.

3. The network monitoring device of claim 1, further comprising:
a sensor for identifying a disconnect in the local Ethernet network and wherein the access controller erases the known media access controller addresses in memory when the sensor identifies a disconnect.

4. The network monitoring device of claim 1, wherein the access controller requires administrator permission prior to broadcasting of packets to multiple identified known media access controller addresses from a single identified port.

5. The network monitoring device of claim 3, wherein the access controller requires administrator permission prior to not erasing the access controller addresses in memory when the sensor identifies a disconnect.

6. The network monitoring device of claim 1, wherein the monitoring device is a field programmable gate array.

7. A network traffic monitoring device for an Ethernet network, comprising:
a connection to a physical media;
a connection to a media access controller of the Ethernet network;
a filter for identifying packets of one or more known media access controllers;
a memory for storing known media access controller addresses; and
an access controller that prevents broadcasts of packets by the media access controller to the media access controller addresses not stored in the memory.

8. The network monitoring device of claim 7, further comprising:
a filter for identifying packets of one or more ports of the Ethernet network wherein the memory stores ports on the Ethernet network and the access controller prevents broadcasts of packets to multiple identified known media access controller addresses from a single identified port.

9. The network monitoring device of claim 7, further comprising:
a sensor for identifying a disconnect in the local Ethernet network and wherein the access controller erases the known media access controller addresses in memory when the sensor identifies a disconnect.

10. The network monitoring device of claim 1, wherein the access controller requires administrator permission prior to broadcasting of packets by the media access controller to the media access controller addresses not stored in the memory.

11. The network monitoring device of claim 8, wherein the access controller requires administrator permission prior to broadcasting of packets to multiple identified known media access controller addresses from a single identified port.

12. The network monitoring device of claim 9, wherein the access controller requires administrator permission prior to not erasing the access controller addresses in memory when the sensor identifies a disconnect.

13. The network monitoring device of claim 7, wherein the monitoring device is a field programmable gate array.

14. A network traffic monitoring device for an Ethernet network, comprising:
a connection to a physical media;
a connection to a media access controller of the Ethernet network;
a sensor for identifying a disconnect in the local Ethernet network;
a memory for storing media access controller addresses on the Ethernet network; and
an access controller that broadcasts of packets to media access controller addresses stored in memory and erases the access controller addresses in memory when the sensor identifies a disconnect.

15. The network monitoring device of claim 14, wherein the access controller prevents broadcasts of packets by the media access controller to the media access controller addresses not stored in the memory.

16. The network monitoring device of claim 14, further comprising:
a filter for identifying packets of one or more ports of the Ethernet network wherein the memory stores ports on the Ethernet network and the access controller prevents broadcasts of packets to multiple identified known media access controller addresses from a single identified port.

17. The network monitoring device of claim 16, wherein the access controller requires administrator permission prior to not erasing the access controller addresses in memory when the sensor identifies a disconnect.

18. The network monitoring device of claim 16, wherein the access controller requires administrator permission prior to broadcasting of packets to multiple identified known media access controller addresses from a single identified port.

19. The network monitoring device of claim 15, wherein the access controller requires administrator permission prior to broadcasting of packets by the media access controller to the media access controller addresses not stored in the memory.

20. The network monitoring device of claim 14, wherein the monitoring device is a field programmable gate array.
